(19) United States
(12) Patent Application Publication
(10) Pub. No.: US 2011/0084559 A1
(43) Pub. Date: Apr. 14, 2011

(54) Direct Linear Drive, Drive Device and Actuating Device

(75) Inventor: Matthias Finkbeiner, Motzingen (DE)

(73) Assignee: FESTO AG & CO. KG, Esslingen (DE)

(21) Appl. No.: 12/997,196

(22) PCT Filed: Jun. 13, 2008
(86) PCT No.: PCT/EP08/04749

§ 371 Date: Dec. 9, 2010

(51) Int. Cl. H02K 41/02

(52) U.S. Cl. 310/12.19

(57) ABSTRACT

The invention relates to a direct linear drive having a stator (12; 112) and a runner (14; 114), to at least one of which electric energy can be applied in order to initiate a translational movement on a coupling element (36; 136); and having a position sensing device (16; 116) for determining the position of the runner (14; 114) in relation to the stator (12; 112); it further relates to a drive device with a direct linear drive of this type and to an actuating device which is equipped with a drive device of this type. According to the invention, the position sensing device (16; 116) is designed as a linear position sensor with a magnetostrictive measuring element (54; 154) and an associated measurement transducer (58; 158).

The invention relates to a direct linear drive having a stator and a runner, to at least one of which electric energy can be applied in order to initiate a translational movement on a coupling element; and having a position sensing device for determining a position of the runner; it further relates to a drive device with a direct linear drive of this type and to an actuating device which is equipped with a drive device of this type.

Direct linear drives are used for generating translational movements which can be introduced into an object to be moved by a coupling element. Their main application is found in the region of automation technology. In addition to widely used fluid-operated direct linear drives such as pneumatic or hydraulic cylinders, for certain actuating tasks electrically controlled direct linear drives such as linear motors or linear stepper motors are used, which are capable of causing a translational movement of the coupling element if subjected to electric energy. For this purpose, such direct linear drives comprise at least two drive elements which are movable relative to each other and which, depending on the design of the direct linear drive, are also designated as stator and runner, and to at least one of which electric energy can be applied.

DE 102 44 261 B4 discloses a coil system which is in particular suitable for an electric direct linear drive. For this purpose, a coil assembly of a plurality of coaxially arranged individual coils is accommodated in a housing. The housing is designed as a back iron and has a cylindrical shape. A longitudinal slot in the housing is provided for the accommodation of a printed circuit board for the control of the individual coils.

To ensure a precise open or even closed loop control of the actuating movements of such direct linear drives, position sensing devices are provided for the detection of the relative positions of the runner and the stator. This position detection may be based either on an incremental measuring system or on an absolute value measuring system.

In this context, DE 197 48 647 C2 discloses an electromagnetic drive system with integrated position signal generation. The drive system is designed as a linear motor and comprises a plurality of discretely controllable electric coils and a permanent magnet arrangement displaceably installed therein. A position of the permanent magnet arrangement within the coils is detected by processing electric voltage curves for the individual coils. This requires a large amount of apparatus, which makes a cost-effective production of such a drive system impossible.

WO 93/15378 shows a sensor which uses for position detection an interaction between a rod of magnetostrictive material, to which an electric signal is applied cyclically, and a permanent magnet displaceably disposed along the rod and representing the position to be detected. The interaction, which is known as Wiedemann effect, results, if the electric signal is fed into the rod of magnetostrictive material by the magnetic field of the permanent magnet located adjacent to the rod, in a local torsional deformation of the rod. This deformation is propagated through the rod as a structure-borne ultrasonic wave and can be detected by a suitable sensor. As the propagation time of the structure-borne ultrasonic wave in the rod, starting from the point of origin which coincides with the position of the permanent magnet, is proportional to the distance between the sensor and the permanent magnet, an absolute length of distance can be detected precisely.

The invention is based on the problem of providing a direct linear drive, a drive device and an actuator device of the type referred to above, which is configured for cost-effective and accurate position sensing.

For the direct linear drive referred to above, this problem is solved by providing that the position sensing device is designed as a linear position sensor with a magnetostrictive measuring element and an associated measurement transducer. In this context, the invention utilises the surprising finding that, if the stator and the runner the electric control for the direct linear drive as well as the evaluation device for the position sensing device are designed appropriately, it is possible, in spite of the electromagnetic fields generated in the operation of the direct linear drive, to achieve stable and accurate position sensing by means of the magnetostrictive measuring principle, using the magnetostrictive measuring element and the associated measurement transducer. In individual cases, shielding measures may be required for the electromagnetic fields generated by the direct linear drive, or the direct linear drive may have to be structurally separated from the position sensing device. In view of the high quality of the measurements which is achievable in this way, the integration of the position sensing device appears to be extremely cost-effective.

In the direct linear drive according to the invention, the stator and/or the runner comprise(s) an electric coil device. The coil device, which may also be designated a field coil device, generates a magnetic field which is controllable in terms of direction and flux density if subjected to electric energy. With this electric field, a force can be applied to the runner to effect the desired translational movement of the coupling element.

The design of the stator and/or runner with a permanent magnet arrangement results in a simple and compact structure of the direct linear drive. This applies in particular to a design in which the runner of the direct linear drive is fitted with permanent magnets, as no electric contacts are required for the provision of magnetic forces at the runner.

In an advantageous further development of the invention, the magnetostrictive measuring element extends along a movement path of the runner. The term “movement path” should be understood to mean the translational displacement range of the runner with respect to the stator, which is in particular limited by the mechanical configuration of the runner and the stator. For a precise detection of the position of the runner relative to the stator, the magnetostrictive measuring element extends at least substantially parallel to the movement path, in particular with an at least partial overlap. The magnetostrictive measuring element preferably has a length which is at least almost equal to the length of the movement path. In a particularly preferred embodiment, the length of the magnetostrictive measuring element is greater than the length of the movement path to allow a precise detection of the position of the runner relative to the stator along the entire movement path. This design further simplifies the mounting of the magnetostrictive measuring element, in particular on the stator.

In an advantageous development, the magnetostrictive measuring element is installed into a movement space provided for the relative movement of the runner with respect to the stator. The term “movement space” describes a volume which is at least substantially bounded by the stator and in which the runner is capable of linear movement and displacement. The positioning of the magnetostrictive measuring element in the movement space results in a compact design of the linear motor, because the movement space is used in two ways. This double use includes the translational movement of the runner relative to the stator and to the magnetostrictive measuring element. The magnetostrictive measuring element preferably projects into a section of the movement space which is remote from an end region of the runner connected to the coupling element, which is in particular represented by an actuating rod.

In a further development of the invention, it is provided that the magnetostrictive measuring element is placed offside a movement space provided for the movement of the runner relative to the stator. This embodiment of the invention offers the advantage that a runner of a conventional structure can be used, which does not have to be adapted to the magnetostrictive measuring element.

The permanent magnets are advantageously designed as annular magnets. Compared to solid magnets, annular magnets are characterised by a better ratio between their weight and the magnetic flux they generate, resulting in a weight-optimised design of the direct linear drive, in particular of its runner. The recesses provided in the annular magnets have an advantageous double function. On the one hand, they reduce the weight of the annular magnets, thereby improving the ratio between their weight and the magnetic flux they generate compared to solid permanent magnets. On the other hand, the free space provided is at least partially used by the magnetostrictive measuring element, which is movable relative to the runner, so that it does not have to be placed at another point in the direct linear drive.

In a further development of the invention, it is provided that the recesses of the annular magnets accommodate a preferably sleeve-shaped internal return device, if the annular magnets are radially magnetised. The internal return device has the purpose of transmitting the magnetic field present radially inwards on the annular magnet with as little loss as possible between an exit from the annular magnet and an entry into the annular magnet, in order to maximise the magnetic field present radially outwards on the annular magnet, which comes to interact with the magnetic forces generated by the coil device. Radially magnetised annular magnets preferably consist of segments (2, 3 or more) distributed around the circumference, which are preferably magnetised diametrically for ease of production and therefore result in a quasi-radial field distribution.

Annular magnets placed adjacent to and in particular on the runner are advantageously provided with a common internal return device. The internal return device mechanically stabilises the annular magnets and shields the measuring system against the fields of the runner.

In an advantageous way, the internal return device may be integrated or manufactured in one piece with the coupling device. This results in a simpler structure for the linear drive.

In a further development of the invention, it is provided that the magnetostrictive measuring element plunges at least partially into the recess of the annular magnet and preferably into a recess of the sleeve-shaped internal return device. This ensures a compact structure of the linear motor and an advantageous electric contacting arrangement for the position sensing device.

The magnetostrictive measuring element is preferably located on the stator, so that a translational movement of the runner with respect to the stator is also a relative movement with respect to the magnetostrictive measuring element. The at least partial overlap between the magnetostrictive measuring element and the runner along the movement path, which is required because of the measuring principle involved, is ensured in an advantageous manner by the plunge of the magnetostrictive measuring element into the runner, because it results in a combined use of the movement space in the stator.

The runner may in particular be designed as an elongated rod with externally mounted permanent magnets, or as an arrangement of annular magnets, in particular with a sleeve-shaped internal return device.

If the runner is designed as an elongated rod with externally mounted permanent magnets, the rod may be provided with a longitudinal bore into which the magnetostrictive measuring element plunges.

In a runner with annular magnets, the magnetostrictive measuring element plunges into the preferably cylindrical recesses of the annular magnets. If the magnetostrictive measuring element is at least partially located in the recess of the sleeve-shaped internal return device, the characteristics of the latter in terms of the conduction of the magnetic fields provided by the annular magnets ensure an at least partial shielding for the magnetostrictive measuring element, resulting in a more precise determination of the length of distance while requiring little in the way of evaluation. This applies in particular to an arrangement in which the magnetostrictive measuring element is arranged coaxially in the recess of the internal return device.

The cross-section of the measuring element and/or of the drive as a whole in a plane lying at right angles to its main dimensional direction may be circular, oval or polygonal.

In an alternative variant of the invention, permanent magnets assigned to the stator and/or to the runner may be magnetised substantially axially. The permanent magnets, which are in particular designed as annular magnets, are preferably arranged in such a way in the direct linear drive that their central axes are at least substantially oriented parallel to the direction of the translational movement which is to be effected. Adjacent permanent magnets are preferably magnetised in opposite directions. In such an axial magnetisation arrangement, there must not be any internal ferromagnetic return. The magnetic field lines are diverted radially outwards. Pole shoes between the permanent magnets may concentrate this magnetic flux even further. This results in a maximum interaction with the magnetic fields of the electrically excitable coil devices which are disposed opposite.

A radially magnetised actuating solenoid is preferably assigned to the runner to act on the magnetostrictive measuring element. In terms of its dimensions and the orientation of its magnetic field, the actuating solenoid is designed for advantageous interaction with the magnetostrictive measuring element and therefore allows a very precise position detection, because the at least substantially radial magnetisation of the actuating solenoid ensures a maximum effect for the magnetic field of the actuating solenoid on the magnetostrictive measuring element.

It is also advantageous if the actuating solenoid is arranged at least substantially coaxial with the annular magnets and offside the internal return element. The magnetic field generated by the actuating solenoid should act on the magnetostrictive measuring element with maximum efficiency, so that a shielding of this magnetic field by the internal return element is not desirable. The actuating solenoid is on the contrary preferably located adjacent to an end region of the internal return element and has a minimum air gap with respect to the magnetostrictive measuring element.

As an alternative, an axially magnetised permanent magnet assigned to the runner, in particular an annular magnet, may be provided to act on the magnetostrictive measuring element. The permanent magnet assigned to the runner, which is provided for interaction with the stator in order to generate the actuating forces, thereby comes to have a double function, because the magnetic field it provides is also used to interact with the magnetostrictive measuring element. Preferably, the magnetic field of the annular magnet of the runner which has the least distance from the coupling element is evaluated in the magnetostrictive measuring element for the generation of the structure-borne ultrasonic wave, while in fact all magnets generate such waves. The sound waves of several magnets may, however, also be used for evaluation.

In another embodiment of the invention, it is provided that the magnetostrictive measuring element is arranged in the radial direction outside annular magnets of the runner, preferably in the radial direction outside of coil elements of the stator, in particular on an inner surface of a sleeve-shaped external return device provided for the accommodation of coil elements. This simplifies the mounting of the magnetostrictive measuring element, because this can advantageously be accommodated in a suitable recess before the coil arrangement is installed into the external return element. In addition, the measuring element can advantageously be accommodated on the inner surface of the external return device and is thereby stabilised.

It is advantageous if the separate actuating solenoid is annular and placed adjacent to an annular magnet assigned to the runner. This results in a particularly simple design and mounting of the actuating solenoid on the drive element.

In a further development of the invention, the actuating solenoid is designed as an annular magnet which is preferably fitted to the internal return device, resulting in a particularly advantageous ratio between weight and the magnetic flux which is generated.

In an annular design of the actuating solenoid, a rotation of the runner about its central axis is irrelevant for the position sensing device, so that a turning of the runner in operation can be tolerated and there are no installation requirements concerning the rotary position of the runner.

The linear position sensor preferably comprises a control unit provided for introducing an electric signal into the magnetostrictive measuring element and coupled to the measurement transducer for the detection of time-dependent vibration amplitudes in the magnetostrictive measuring element. With this control unit, the electric signal required for the interaction between the magnetostrictive measuring element and the actuating solenoid is fed into the measuring element. In addition, the control unit is used for the evaluation of the electric signals provided by the measurement transducer and generated by the structure-borne ultrasonic waves in the magnetostrictive measuring element, and thus for the detection of the position of the runner relative to the stator.

In a further development of the invention, the control unit is configured for the detection of a maximum vibration amplitude within a presettable time interval after the feed-in of the electric signal. Owing to the electric control of the coil devices for the generation of the translational movement of the runner, and owing to the magnetic fields of the annular magnets serving as drive elements, several structure-borne ultrasonic waves detectable by the measurement transducer are generated in the magnetostrictive measuring element, because any magnetic field at right angles to the measuring system generates a torsional wave. If two actuating solenoids are arranged at a defined distance, for example, the runner can be coded accordingly, and error suppression is possible. In this case, two signals are detected, which have to have the same distance as the solenoids; otherwise error signals are present. If, for example, the distance differs from the coil spacing and the magnet spacing of the runner, these errors can be filtered out. In this way, certain runners can be recognised, for example by choosing a special spacing for a custom design.

In the control unit, the maximum and/or minimum signal amplitude is preferably determined, because we have to consider that the actuating solenoid which is provided for position detection and which is preferably magnetised radially has caused the maximum and/or minimum signal amplitude in the amplitude family within the preset time interval, which can in particular be used for error suppression. In a particularly preferred embodiment, the control unit is equipped with a memory device for storing calibration values for a particularly precise measuring result.

By placing the control unit in an end region remote from the coupling element, preferably on a common printed circuit board with a drive for the at least one drive element, a simple electric contacting of the control unit can be ensured. The control unit is preferably coupled electrically to the drive for the direct linear drive, so that the position of the runner can be controlled on the basis of a comparison between the set and actual values between drive and control unit. It is particularly advantageous if the drive and the control unit are formed on a common printed circuit board, in particular on an at least partially flexible circuit board.

According to a further aspect of the invention, a drive device is provided which has a preferably cylindrical housing in which a direct linear drive according to the invention is accommodated. In a double function, the housing of the drive device may be designed as an external return for the direct linear drive. The housing is preferably designed such that it can, according to a further aspect of the invention, be installed into a cylinder housing of an actuating device configured for the accommodation of a pneumatic piston. In this way, a modular arrangement can be implemented for the direct linear drive, wherein it is easy to switch between an fluid-operated and an electric direct linear drive.

Embodiments of the invention are illustrated in the drawing and explained in greater detail in the following description. Of the drawing:

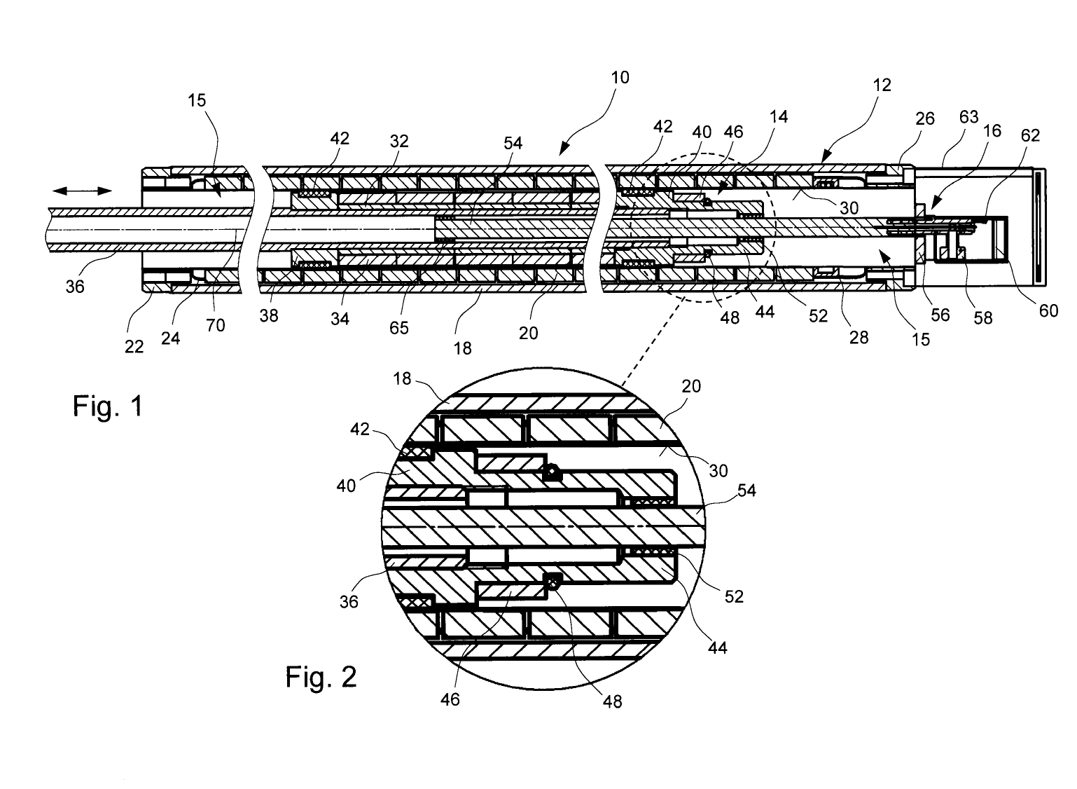

FIG. 1 is a sectional view of a first embodiment of a direct linear drive with an integrated position sensing device;

FIG. 2 is an enlargement of a section of the direct linear drive according to FIG. 1;

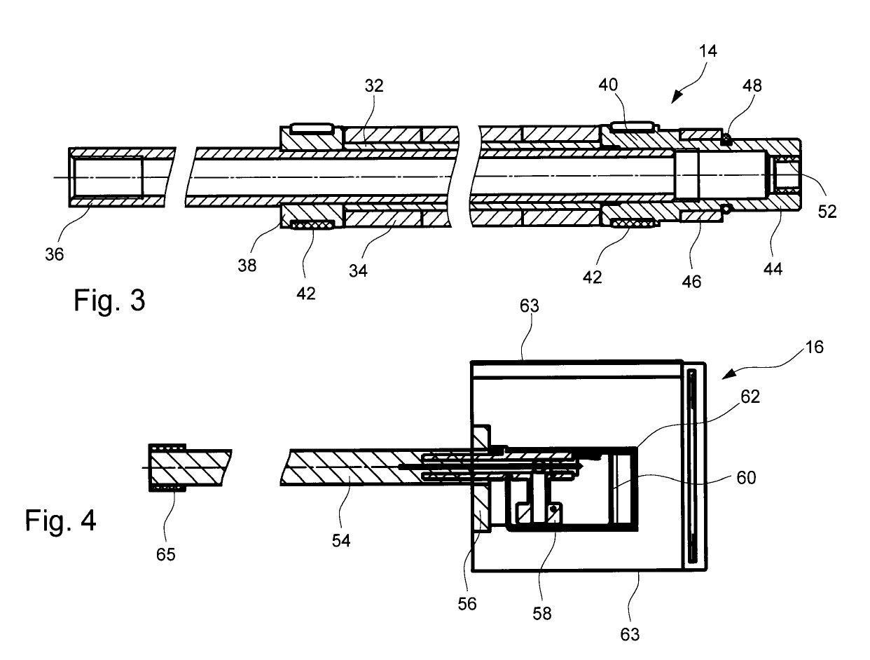

FIG. 3 shows a runner for the direct linear drive according to FIGS. 1 and 2;

FIG. 4 shows a measuring rod with a coupled processing device for the direct linear drive according to FIGS. 1 and 2;

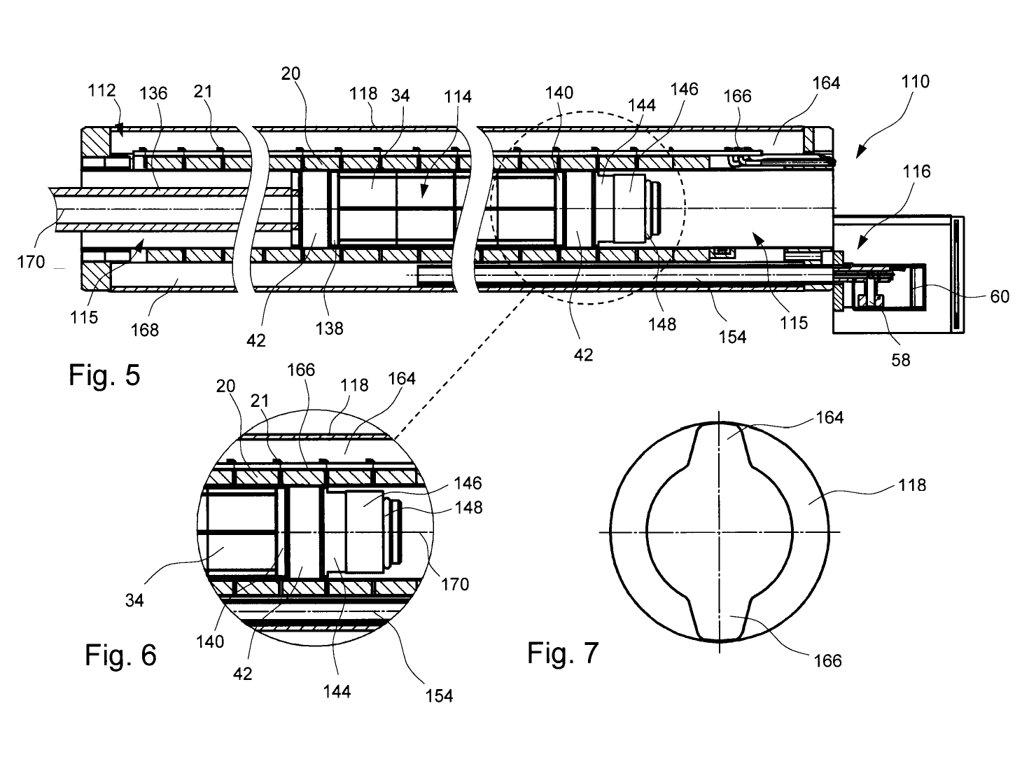

FIG. 5 is a sectional view of a second embodiment of a direct linear drive with an integrated position sensing device;

FIG. 6 is an enlargement of a section of the direct linear drive according to FIG. 5; and

FIG. 7 is an end view of a housing tube for the direct linear drive according to FIGS. 5 and 6.

The linear motor 10 shown in FIG. 1 comprises a stator 12 and a runner 14 which is accommodated for relative movement in a recess 15 of the stator 12 which serves as a movement space; this runner is shown in greater detail in FIG. 3. For detecting a translational position of the runner 14 relative to the stator 12, a position sensing device 16 is provided, which is designed as an absolute value measuring system and which is shown in greater detail in FIG. 4.

The stator 12 comprises a cylindrical housing tube 18 which forms both the outer casing for the linear motor 10 and a screen or shielding and magnetic return or back iron for annular magnets 34 of the runner located inside the housing tube 18, provided that these annular magnets 34 are magnetised radially. If the annular magnets 34 are magnetised radially, the housing tube 18 is preferably thick-walled and ferromagnetic, as otherwise considerably power losses have to be expected, which would not happen in the case of axially magnetised annular magnets. Further benefits are a screening against interference by magnetic fields of the motor and an advantageous magnetic return, which also applies to axially magnetised annular magnets, which may have a thin-walled ferromagnetic housing tube 18. In the case of axially magnetised annular magnets, the housing tube 18 may alternatively be non-ferromagnetic.

The stator 12 comprises coils 20 which form a field coil arrangement and are wound in the known manner from coated copper wire. Winding ends of the coils 20, which are not shown in the drawing, are electrically connected to a flexible circuit board extending almost along the entire length of the housing tube 18, which is likewise not shown in the drawing. The flexible circuit board allows electric energy to be applied individually to the coils 20 and is disposed between the inner surface of the housing tube 18 and the outer surfaces of the coils 20.

In an end region of the housing tube 18 which is shown on the left-hand side in FIG. 1, an annular end plug 22 is provided which has a smaller diameter than the housing tube 18 and serves as a stop for an annular compression spring 24 which applies an axial preload to the coils 20. In an end region of the housing tube 18 which is shown on the right-hand side in FIG. 1, a second end plug 26 is provided, which likewise has a smaller diameter than the housing tube 18 and serves as an abutment for an annular support element 28 which bears against the free end face of the coil 20 and supports it against the pressure of the compression spring 24. Both end plugs 22, 26 are welded to the housing tube 18.

The inner surfaces if the coils 20 bound a cylindrical cavity in which is provided a sliding sleeve 30 made of a thin-walled plastic material or a non-screening material such as stainless steel and extending almost along the entire length of the linear motor 10. This bridges the joints and gaps between the coils 20 and the compression spring 24 or the support element 28 at the ends of the housing tube 18, thereby providing a cylindrical inner surface for the runner 14. The sliding sleeve 30 further provides friction conditions which are as even as possible along the entire length of the linear motor 10 for the runner 14, which is subject to static friction at rest and to sliding friction in motion. In individual cases, the sliding sleeve 30 can be omitted, for example if a potting compound acts as a sliding sleeve 30.

The runner 14, which is shown in greater detail in FIG. 3, consists of several assemblies in a concentric arrangement. A first assembly comprises a cylindrical return tube 32 made of a ferromagnetic material and radially magnetised annular magnets 34 applied thereto by adhesive force, which consist of annular part-segments not shown in the drawing and are for example adhesive-bonded to the return tube 32. The return tube 32 is pushed onto hollow-cylindrical inner tube 36, its ends bearing against a front sliding bush 38 and a rear sliding bush 40. The front sliding bush 38 is an annular metal body supporting a sliding ring 42 in a continuous groove. The sliding ring 42 is made of a plastic material and has a low coefficient of friction in interaction with the surface of the sliding sleeve 30. The rear sliding sleeve 40, which is screwed to an end region of the inner tube 36, is also a rotationally symmetric body and likewise supports a plastic sliding ring 42 in a continuous groove.

With an annular end face facing the front sliding bush 38, the rear sliding bush 40 bears against the free end face of the adjacent annular magnet 34, thereby securing its axial positioning on the return tube 32. In the end region remote from the annular magnets 34, the sliding bush 40 has a hollow-cylindrical extension 44. This extension 44 supports on its outer circumference an annular magnet 46 acting as an actuating solenoid, which is magnetised in the radial direction and secured against axial movement by a circlip 48. On an inner surface of a bore provided in the extension 44, a sleeve-like bearing ring 52 made of a plastic material is provided to act as a plain bearing with respect to a measuring rod 54 located concentrically in the housing tube 18 and made of a magnetostrictive material.

In contrast to the runner 14, which is displaceably accommodated in the sliding sleeve 30, the measuring rod 54, which is shown in greater detail in FIG. 4, is fixed to the rear end plug 26 of the linear motor 10 by means of a retaining web 56. According to FIG. 1, the cylindrical measuring rod 54, extends to the right beyond the housing tube 18 and is in the projecting region coupled to a torsion sensor 58 serving as a measurement transducer and configured for a detection of torsional vibrations in the measuring rod 54. Together with a control circuit board 60, the torsion sensor 58 is accommodated in a housing 62 which is in turn surrounded by a protective cap 63. This protective cap also protects an end region of the flexible circuit board provided for the supply of the coils 20 and ends of electric wires attached thereto but not shown in the drawing, which run out of the protective cap 63 in a supply cable which is likewise not shown in the drawing.

In an end region of the measuring rod 54 which is remote from the torsion sensor 58, a bearing bush 65 is bonded thereto for the support and low-friction sliding mounting of the measuring rod 54 on the cylindrical inner surface of the inner tube 36.

Like a pneumatic cylinder or a hydraulic cylinder, the linear motor 10 can induce a direct linear movement into the inner tube 36. For this purpose, electric energy is applied to the coils 20, resulting in an interaction between the magnetic fields generated in the coils 20 and the magnetic fields of the annular magnets 34 manufactured as permanent magnets. The force acting on the runner 14 as a result of the interaction between the magnetic fields can cause a translational displacement of the runner 14 in accordance with the directional arrow in FIG. 1. The translational movement of the runner 14 runs parallel to the central axis 70 between two end positions which are not shown in FIGS. 1 to 4. The forces acting on the runner 14 considerably exceed the forces required to overcome the static and dynamic friction between the runner 14 and the stator 12, so that an actuating element coupled to the inner tube 36, which is not shown in the drawing, can be moved.

In order to determine the position of the runner 14 relative to the stator 12, an electric signal, in particular a square-wave signal, is cyclically applied to the measuring rod 54 by a drive circuit on the control circuit board 60. This signal runs through the measuring rod 54 and is at an end of the measuring rod 54 which is remote from the control circuit board 60 fed back to the control circuit board 60 via an electric conductor not shown in the drawing. The electric signal fed into the measuring rod 54 generates a locally changeable magnetic field running with the signal. The interaction with the radial magnetic field generated by the actuating solenoid 46 causes at the position of the actuating solenoid 46 a torsional vibration in the measuring rod 54, which propagates in the measuring rod 54 as a structure-borne ultrasonic wave and which can be detected by the torsion sensor 58. Based on the knowledge of the time difference between the transmission of the electric signal into the measuring rod 54 and the arrival of the structure-borne ultrasonic wave at the torsion sensor 58, the absolute position of the actuating solenoid 46 along the measuring rod 54 and thus the position of the runner 14 relative to the stator 12 can be determined.

Notwithstanding the current applied to the coils 20 and the accompanying dynamic electromagnetic fields, the electrically controllable linear motor 10 makes use of the position sensing device based on the interaction between the magnetostrictive measuring rod 54 and the actuating solenoid 46 and thus combines a precise detection of the position of the runner 14 with a relatively simple structure for the linear motor 10.

In an embodiment of the invention which is not illustrated, the annular magnet serving as an actuating solenoid is placed in the bore of the extension 44 of the rear sliding bush 40, preferably in place of the bearing ring 52. As a result, the radial field generated by the actuating solenoid has to overcome an even smaller air gap than in the embodiment according to FIGS. 1 and 2, and the actuating solenoid can be smaller. In addition, there is a particularly advantageous relationship between the magnetic fields provided by the coils 20 and the annular magnets 34 on the one hand and the magnetic field of the actuating solenoid on the other hand. In this embodiment, the inner surface of the actuating solenoid can be provided with a plastic coating in order to ensure advantageous friction characteristics with respect to the measuring rod 54.

In the description of the second embodiment shown in FIGS. 5 to 7, the same reference numbers are used for components of identical function as for the first embodiment shown in FIGS. 1 to 4. The reference numbers for different components have been increased by 100.

In the linear motor 110 according to FIGS. 5 to 7, the runner 114 is likewise made up from several assemblies. The radially magnetised annular magnets 34, which are not shown in section in FIGS. 5 and 6, are like in the case of the runner 14, adhesive-bonded as annular part-segments to an invisible return tube, which is in turn pushed onto an inner tube 136. Here, too, the return tube is omitted in axially magnetised annular magnets 34. Sliding bushes 138 and 140, which are likewise mounted on the inner tube 136 and which are in turn provided with sliding rings 42, bear against the end faces of the annular magnets 34. An extension 144 of the rear sliding bush 140 supports an annular magnet 146 serving as an actuating solenoid, which is magnetised in the radial direction. In the axial direction, the annular magnet 146 is located on the extension 144 by a circlip 148.

The stator 112 of the linear motor 110 basically has the same structure as the stator 12 of the linear motor 10 and is provided with a cylindrical recess 115 serving as a movement space for the runner 114. In contrast to the embodiment of the linear motor 10, the housing tube 118 of the linear motor 110 has a profiled inner cross-section as shown in detail in FIG. 7. The longitudinal groove 164 in the housing tube 118 accommodates the printed circuit board 166 shown in FIGS. 5 and 6. This is connected to winding ends 21 of the coils 20 and enables the provision of electric energy to the coils 20. The longitudinal groove 164 in the housing tube 118 also accommodates the measuring rod 154, which extends substantially parallel to a central axis 170 of the runner 114. The measuring rod 154 is located in the longitudinal groove 166 by means of a toughened potting compound not shown in the drawing, the coefficient of elasticity of the potting compound being chosen such that the torsional vibration propagated through the measuring rod 154 is damped only minimally. As an alternative, a protective sleeve can be provided for the measuring rod 154, which would also prevent its sticking.

The position sensing device 116 has the same structure and the same function as the position sensing device 16. In the embodiment of the invention shown in FIGS. 5 to 7, the radial magnetisation and the end location of the actuating solenoid 146 ensure that the resulting structure-borne supersonic wave causes the strongest signal amplitude, which arrives first at the torsion sensor 158 in terms of time and which can therefore reliably be distinguished from weaker and later arriving signal amplitudes, so that the position of the actuating solenoid 156 can be determined accurately.

Instead of the detection of a torsional vibration, a longitudinal vibration can be generated and detected if the external magnetic field to be applied by the actuating solenoid is chosen accordingly. If a suitable material is chosen for the measuring rod, a volume change can be effected, which would also result in a measurable structure-borne ultrasonic wave.

1. Direct linear drive having a stator and a runner, to at least one of which electric energy can be applied in order to initiate a translational movement on a coupling element; and having a position sensing device for determining the position of the runner in relation to the stator, wherein the position sensing device is designed as a linear position sensor with a magnetostrictive measuring element and an associated measurement transducer.

2. Direct linear drive according to claim 1, wherein the stator and/or the runner comprise(s) an electric coil device.

3. Direct linear drive according to claim 1, wherein the stator and/or the runner comprise(s) a permanent magnet arrangement.

4. Direct linear drive according to claim 1, wherein the magnetostrictive measuring element extends along a movement path of the runner.

5. Direct linear drive according to claim 1, wherein the magnetostrictive measuring element is disposed in a movement space provided for the relative movement of the runner with respect to the stator or offside this movement space.

6. Direct linear drive according to claim 3, wherein the permanent magnet arrangement comprises permanent magnets designed as annular magnets.

7. Direct linear drive according to claim 6, wherein a sleeve-shaped internal return device is provided in a recess of the permanent magnet arrangement.

8. Direct linear drive according to claim 7, wherein annular magnets of the permanent magnet arrangement, which are disposed on the runner, have a common internal return device.

9. Direct linear drive claim 7, wherein the magnetostrictive measuring element dips at least partially into a recess of the sleeve-shaped internal return device.

10. Direct linear drive according to claim 3, wherein the magnetostrictive measuring element is disposed radially outside annular magnets of the runner and on an inner surface of a sleeve-shaped external return device provided for the accommodation of coil elements.

11. Direct linear drive according to claim 7, wherein the internal return device is integrated with the coupling element.

12. Direct linear drive according to claim 1, wherein permanent magnets of the permanent magnet arrangement which are assigned to the stator and/or to the runner have a substantially axial or radial magnetisation.

13. Direct linear drive according to claim 1, wherein at least one permanent magnet of the permanent magnet arrangement of the runner is provided as an actuating solenoid for acting on the magnetostrictive measuring element.

14. Direct linear drive according to claim 1, wherein a radially magnetised actuating solenoid assigned to the runner is provided for acting on the magnetostrictive measuring element.

15. Direct linear drive according to claim 14, wherein the actuating solenoid is disposed at least substantially coaxial with the annular magnets of the permanent magnet arrangement of the runner and offside the internal return element and adjacent to an annular magnet assigned to the runner.

16. Direct linear drive according to claim 1, wherein the linear position sensor comprises a control unit, which is provided for introducing an electric signal into the magnetostrictive measuring element and which is coupled to the measurement transducer for the detection of time-dependent vibration amplitudes in the magnetostrictive measuring element, wherein the control unit is configured for a determination of at least one maximum and/or minimum vibration amplitude within a presettable time interval after the introduction of the electric signal into the magnetostrictive measuring element.

17. Direct linear drive according to claim 16, wherein the control unit is disposed in an end region remote from the coupling element on a common printed circuit board with a drive circuit for the at least one drive element.

18. Drive device with a cylindrical housing, in which a direct linear drive according to claim 1 is accommodated.

19. Actuating device with a cylinder housing configured for the accommodation of a pneumatic piston, wherein a drive device according to claim 18, is disposed in the cylinder housing.
